(19) United States
(12) Patent Application Publication
(10) Pub. No.: US 2026/0177987 A1
(43) Pub. Date: Jun. 25, 2026

(54) WATCH BEZEL WITH CAVITY FOR CONTAINING A FLUID

(71) Applicant: The Swatch Group Research and Development Ltd, Marin (CH)

(72) Inventors: Julie DREON, Neuchâtel (CH); Cédric Nicolas, Neuchâtel (CH); Bernat Monferrer, St-Prex (CH)

(73) Assignee: The Swatch Group Research and Development Ltd, Marin (CH)

(21) Appl. No.: 19/404,520

(22) Filed: Dec. 1, 2025

(30) Foreign Application Priority Data
Dec. 20, 2024 (EP) 24222405.3

(51) Int. Cl. G04B 37/02; G04B 19/28; G04B 45/00

(52) U.S. Cl. CPC G04B 37/02; G04B 19/283; G04B 45/0069

(57) ABSTRACT

A bezel for a timepiece including: a cavity for containing a fluid, the cavity having an annular cross-section and including two projecting edges in the form of an inner bow and of an outer bow forming an inner contact surface and an outer contact surface; a bezel glass with an annular cross-section, closing the upper part of the cavity and being in contact with the inner contact surface and the outer contact surface; an inner joint on the inner perimeter of the glass and in contact with the inner contact surface; and an outer joint on the outer perimeter of the glass and in contact with the outer contact surface.

### CROSS-REFERENCE TO RELATED APPLICATIONS

This application claims priority to European Patent Application No. 24222405.3, filed on Dec. 20, 2024, the entire contents of which are incorporated herein by reference.

### TECHNICAL FIELD OF THE INVENTION

The present invention relates to the field of horology and more specifically to the field of bezels for wristwatches. The present invention also relates to a method of water-resistant fastening of the bezel to enable it to contain a fluid.

### TECHNOLOGICAL BACKGROUND

Watch bezels are well known in the prior art, and are generally solid, meaning that they do not contain any voids. A solid bezel within the meaning of the present invention is either a bezel with no voids or cross-outs, or a bezel with a cross-out filled with a solid material which then makes the bezel solid. In general, a bezel glass is then glued onto the bezel. The glass can also be driven in on the bezel with a joint on the outer perimeter of the glass, in addition to gluing.

Watch bezels can play many different roles, both decorative and functional. For example, they can be set with stones using different techniques or comprise a graduation to indicate minutes or other data. The well-known rotating bezel on a diving watch is used to measure the time elapsed since the start of the dive. Watch bezels can therefore come in a wide range of geometries and with all kinds of functions.

Preferably, when the watch glass is driven into the bezel, the bezel must be fastened to the watch middle in a water-resistant manner to avoid any infiltration into the case. For example, EP0628895 describes a watch bezel with a double O-ring between the bezel and the watch middle.

There is currently a real interest in optimising the functions of watch bezels to make them more efficient and provide them with different uses.

### SUMMARY OF THE INVENTION

The invention aims to provide a watch bezel comprising a cavity containing a fluid, which can be a liquid or a gas. The present invention aims to provide a water-resistant bezel to ensure that the fluid is kept inside it.

The invention also aims to provide a bezel with an upper glass for closing the cavity while allowing the user to see inside.

Another aspect of the invention relates to the development of a method of water-resistant fastening of the watch bezel cavity so as to contain the fluid.

### BRIEF DESCRIPTION OF THE FIGURES

The present invention is illustrated by an example shown in the following figures:

FIG. 1 is a cross-sectional plane of an example of a crossed-out watch bezel according to the present invention;

FIGS. 2 and 3 are an enlargement of FIG. 1, with the bezel glass closing the cavity in a water-resistant manner by means of a double joint.

### DETAILED DESCRIPTION OF THE INVENTION

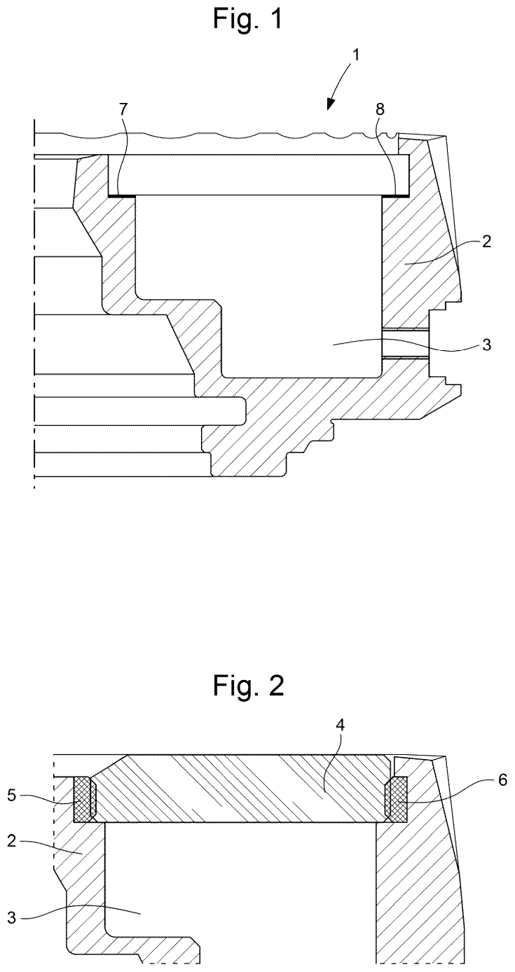

As illustrated in FIG. 1, the bezel 2 in the present invention comprises a cavity 3 recessed therein. The purpose of this cavity 3 is to contain a fluid of any type, whether liquid or gas. The cavity 3 preferably has a bow-shaped cross-section, since it is recessed into the entire bezel 2, which is itself annular in shape. If the bezel 2 is recessed to a certain depth and then filled with a solid at the back of the recess over part of the depth so as to leave a void above the solid that can be filled with a fluid, the cavity 3 within the meaning of the present invention corresponds to the solid-free recess.

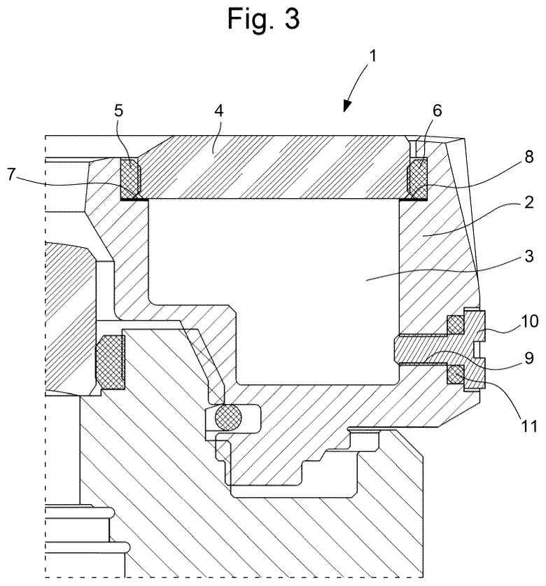

Moreover, the cavity 3 comprises two protruding rims on its upper part, namely the part of the cavity on the dial side of the watch 1. The protruding rims are in the form of an inner bow and of an outer bow, forming inner contact surfaces 7 and outer contact surfaces 8, which will enable a bezel glass 4 to be fastened, as shown in FIG. 2, to close the cavity 3 and keep the fluid inside. The bezel glass 4 also preferably has an annular shape for closing the annular cavity 3 of the bezel 2.

The junction between the contact surfaces 7, 8 of the cavity and the bezel glass 4 must therefore be water-resistant to gases and liquids. Since a bezel 2 containing a fluid has never been disclosed in the prior art, the matter of water resistance between the bezel and the bezel glass has never arisen.

According to the present invention, the contact surfaces 7, 8 correspond to the inner and outer bows on the protruding rims of the cavity 3. The inner side of the glass 4, that is, the part with the smallest diameter, is in contact with contact surface 7 and the outer side of the glass 4, that is, the part with the largest diameter, is in contact with contact surface 8.

These available contact surfaces 7 and 8 are very small compared with the complete surface of a solid bezel in the prior art, which does not comprise a cavity. As a result, if the glass 4 were only glued to these minimal surfaces, the reliability of the system would be compromised, as its mechanical strength, shock resistance and chemical resistance would be too low.

The present invention accordingly provides a double joint, namely an inner joint 5 on the inner perimeter of the glass 4 and an outer joint 6 on the outer perimeter of the glass 4, in contact with the contact surfaces 7, 8 of the bezel 4. This double joint is preferably a driven-in joint, used by a system for driving in the glass to improve the water resistance and guarantee sufficient mechanical, chemical and shock resistance.

As shown in FIG. 1, the cavity 3 can also comprise a filling port 9. This is preferably located at its lower level. The bezel 2 can thus be filled with fluid via this port 9 even if it has already been closed by the glass 4 so as to be water-resistant. The filling port 9 is sealed so that it is water-resistant by means of a screw 10 and an O-ring 11 around it. The port 9 can be opened and closed using this screw 10, for example to change the fluid. The cavity 3 can also be filled with the fluid before closing it with the glass 4, if the cavity does not comprise a filling port 9.

The pressure applied to the glass 4 in the driving-in step is preferably comprised between 1,500 and 2,500 N, preferably between 1,800 and 2,300 N, and even more preferably between 1,900 and 2,100 N.

The type of joint used in the present invention corresponds to any type of joint used in the horology field, particularly i-ring joints made of Hytrel, Zytel, Arnitel, etc.

The method of fastening the cavity by driving in the bezel glass 4 can advantageously be carried out by immersion.

As a variant embodiment, joints 5 and/or 6 can be provided in the form of glue-in joints that ensure the water-resistant fastening of the cavity 3 while securing the glass 4 to the bezel 2.

### Terminology

1. Watch
2. Bezel
3. Cavity recessed in the bezel
4. Bezel glass
5. Inner joint
6. Outer joint
7. Inner contact surface for the bezel glass
8. Inner contact surface for the bezel glass
9. Filling port
10. Filling port fastening screw
11. Water-resistant O-ring for fastening the filling port

1. A bezel (2) for a timepiece, comprising:
a cavity (4) for containing a fluid, said cavity having an annular cross-section and comprising two protruding edges in the form of an inner bow and of an outer bow forming an inner contact surface (7) and an outer contact surface (8);
a bezel glass (4) with an annular cross-section, closing the upper part of the cavity (3) and being in contact with said inner contact surface (7) and said outer contact surface (8);
an inner joint (5) on the inner perimeter of the glass (4) and in contact with said inner contact surface (7); and
an outer joint (6) on the outer perimeter of the glass (4) and in contact with said outer contact surface (8).

2. The bezel (2) according to claim 1, wherein the inner (5) and outer (6) joints are “driven in” joints.

3. The bezel (2) according to claim 1, wherein the inner (5) and outer (6) joints are “I-ring” joints.

4. The bezel (1) according to claim 1, wherein the cavity (3) comprises a filling port (9), detachably closed by an assembly comprising a screw (10) and an O-ring (11).

5. A timepiece comprising the bezel (2) according to claim 1.

6. A method of water-resistant fastening of the bezel (2) according to claim 1, comprising the following steps:
fitting an inner joint (5) on the inner contact surface (7);
fitting an outer joint (6) on the outer contact surface (8); and
fastening the cavity (3) by fastening the glass (4) to said contact surfaces (7, 8) using a technique for driving in the glass (4).

7. The method of water-resistant fastening of the bezel (2) according to claim 6, further comprising a step in which the cavity (3) is filled with a fluid.

8. The method of water-resistant fastening of the bezel (2) according to claim 6, wherein the pressure applied to the glass (4) in the driving-in step is comprised between 1,500 and 2,500 N.

9. The method of water-resistant fastening of the bezel (2) according to claim 6, wherein the closure is carried out by immersion in a fluid.
